(19) United States
(12) Patent Application Publication
(10) Pub. No.: US 2008/0160484 A1
(43) Pub. Date: Jul. 3, 2008

(54) Packaging and Process For Homogenizing Dental Material

(75) Inventors: Robin Huhn, Rodenbach (DE); Ulrich Koops, Rossdorf (DE); Novica Savic, Ranstadt (DE); Ozlem Weiss, Frankfurt am Main (DE); Yohannes Woldegergis-Kirchmann, Hanau (DE)

Correspondence Address: NORRIS, MCLAUGHLIN & MARCUS, PA, 875 THIRD AVENUE, 18TH FLOOR, NEW YORK, NY, 10022, US

(73) Assignee: HERAEUS KULZER GMBH, HANAU (DE)

(21) Appl. No.: 11/718,124

(22) PCT Filed: Nov. 1, 2005
(86) PCT No.: PCT/EP05/11669

§ 371 Date: Jul. 12, 2007

(30) Foreign Application Priority Data
Nov. 12, 2004 (DE) 10 2004 054 875.7

(51) Int. Cl. A61C 13/09; B65D 25/00; B65D 71/06

(52) U.S. Cl. 433/213; 206/219; 206/568

(57) ABSTRACT

The invention relates to a packaging unit for homogenising ceramic slurry in mixing devices with at least one packaging vessel, which exhibits a releasable closure, containing ceramic slurries or their components in pre-metered quantities.

The invention relates to a packaging unit and a process for homogenising ceramic dental material, in particular slurry, for the preparation of a ceramic crown, a bridge or an inlay.

In the field of dental prosthetics, ceramic material is used for different products and working processes such as e.g. in making mixed ceramic or fully ceramic dental prostheses. Ceramic slurries are known and used as standard in industry for preparing ceramic materials by means of slurry casting or slurry dipping. In this process, slurries are used which represents an aqueous suspension of ceramic particles, e.g. of aluminium oxide. Consequently, slurry is a suspension of Al₂Oparticles. Previously, slurry had to be produced manually directly before moulding by accurately metering the ceramic powder and the dispersion liquid since, due to sedimentation, a sediment is formed in the slurry and moulding and/or processing is prevented. If additives and or fillers are required, the sequence, agitation times and rates of agitation must be appropriately taken into account during mixing. Depending on the moulding process, complex formulations may be required which provide the slurry with the corresponding viscosity and open time. Moreover, aspects such as toxicology, biocompatibility and residue-free combustion on sintering must be taken into account in the case of the additives, in particular, if the moulded parts produced from the slurry are to be used in the medical or the dental prosthetics field. The process for the preparation of ceramic slurries in the dental prosthetics field is consequently highly time-consuming and prone to errors.

By means of the Vita In Ceram® slurry technology (Vita Zahnfabrik, Bad Säckingen)¹, the use of ceramic slurries in the dental sector was developed for the first time. For a better understanding of the preparation of fully ceramic dental prostheses from slurries, the process is to be explained as follows: ¹ H. Schwickerath, dental-labor 37 (11), 1597 (1989)

An aluminium oxide powder is admixed in portions, in an accurately determined mixing ratio, to an aqueous mixing acid solution (5 ml of solution per 38 g of powder). The Al₂O₃ particles are separated from each other by a thin liquid film in such a way that they are able to slide passed each other if the system is kept in motion. As soon as the slurry is at rest, the particles drop to the bottom of the vessel and become compacted such that the water between the particles is squeezed out. This has the result that the slurry loses its free-flowing properties and a solid bottom sediment is formed which is no longer processable. Consequently, it is important to process the viscous slurry rapidly. The Vita process is a layer technique in the case of which a cap is modelled on a special plaster cast stump. Alternatively, the special plaster cast stump can be dipped into the slurry². ²M. Sadoun, In-Ceram: 10 years of testing. In: Kappert H (Hrsg), Vollkeramik; (ceramics only products: material information—dental prosthetics—clinical experience) Quintessenz Verlag, Berlin 1996:193-221

For moulding, the original plaster cast stump must be duplicated using special plaster of Paris. Subsequently, rapid processing takes place. The moulding process is based on compacting of the particles on the model by dehydrating the slurry through the porous plaster of Paris. The special plaster of Paris exhibits defined shrinkage during thermal treatment and guarantees that the model detaches itself from the cap. The small cap thus produced which is then still present on the special plaster cast stump in placed in the furnace for initial firing. During the first step, dehydration of the plaster of Paris takes place which results in the shrinkage of the model and the small cap becoming detached as a result and a chalk-like, still fragile moulded body (preform) being obtained. The thermal treatment is prolonged and critical since the plaster of Paris is able to detach itself too rapidly in the case of a wrong temperature control and the cap thus becomes cracked.

The second step involves sintering of the preform at a temperature of 1120° C. In the case of this thermal treatment, the Al₂O₃ particles cake together at their contact points without melting. A porous white cast (presintered ceramic moulded body) is formed whose nature and degree of porosity depend on the particle size and particle distribution.

For the final strength, the white preform is subsequently “infiltrated” with lanthanum glass. This step takes place at a temperature of 1100° C. so that the lanthanum oxide glass melts and is absorbed by the Al₂O₃ framework. In this way, the pores of the ceramic material are filled and the working material overall is compacted.

Following processing, mixing with thermally matched mixing compounds having a lower thermal expansion coefficient (TEC) that the infiltrated framework takes place. In this way, a desirable compressive stress is produced in the mixture ensuring additional strength ². ²M. Sadoun, In-Ceram: 10 years of testing. In: Kappert H (Hrsg), Vollkeramik; (ceramics only products: material information—dental prosthetics—clinical experience) Quintessenz Verlag, Berlin 1996:193-221

From the technical point of view of the material, this process is cost-effective though it contains a number of manual steps. From this process, the Wolceram® process³ has been developed which is based on a different type of moulding and in which many steps are carried out in an automated manner. ³ D. Comiskey, Quintessenz 28, 4, 390-398 (2002)

From a slurry, a cap is produced by electrophoretic deposition on a working model which cap is subsequently additionally mill-cut in an automated manner. For this purpose, the dental technician mixes first of all the original slurry manually, as in the case of the layer technique, coats the plaster cast model with a release agent and an electrically conductive layer and clamps it into the device. Subsequently, the model is digitally scanned by laser scanning and then dipped into the slurry. On applying a flow of current, a small cap is deposited which is subsequently mill-cut mechanically on the basis of the digital data in order to achieve a homogeneous layer thickness.

In this case, the slurries are usually mixed by hand—as described. It is the aim of the invention, to improve the mixing process.

The task is achieved according to the invention by the characteristics of the independent claims. Advantageous embodiments are indicated in the dependent claims. The result being that a slurry is provided in a packaging which can be shaken, for example, with a conventional amalgam mixer or a mixing device for dental casting materials. In this way, the dental technician obtains the required slurries in the right consistency and suitable homogeneity in a simple manner. Being non-returnable, so-called single dose packaging, the packaging units are relatively small so that the material can be used up rapidly.

Experiments have shown that shaking or milling by hand is also possible but more time-consuming while treatment in a capsule mixer leads, surprisingly, to excellent results and the time requirement is reduced by a multiple.

Consequently, the invention relates to packaging units for homogenising ceramic slurries in mixing devices with at least one packaging vessel which exhibits a releasable closure, containing ceramic slurries or their components in pre-metered quantities. The packaging unit may be formed of plastic, metal or a combination thereof.

Moreover, the invention relates to a process according to which the slurry is mixed with a mixing device in the packaging unit. During this process, the packaging unit is preferably shaken with a shaking frequency of between 1 Hz and 20 kHz and a shaking time of 30 minutes to 1 second.

The packaging unit can be used to homogenise ceramic slurry in a mixing device or as a dipping vessel in which a basic body, in particular a dental stump model is dipped into the homogenised slurry. In this way, the vessel preferably serves not only as packaging but also as an operating device/vessel for further work carried out by a dental technician.

Preferably, the packaging units are closed units and designed in such a way that they can be clamped and shaken in conventional amalgam or cement mixers or mixing devices for dental casting materials.

Such mixers (DE 41 06 388 C2), retaining facilities therefore (DE 198 14 84 1A1) and corresponding capsules (DE 92 12 249U1, DD 28 55 50 A5, DE 9017 524 U1, DE 299 19 547 U1, DE 90 13 328 U1, DE 29 31 262 C2, DE 31 16 155 C2) are known. However, the ceramic slurry can be stored as a single component system without problems. For this reason, no mixing capsules with chambers separated from each other need to be used. For this reason, the type of packaging unit according to the invention will, instead, be based on the external shape of known capsules.

Known shaking devices, mixers, vortexers or amalgamators (e.g. Lapmix from 3M) have proved suitable; however, the commercially available pieces of equipment are not designed for the quantities of slurry required for producing a fully ceramic cap.

In contrast to known amalgam or dental cement capsules, separation of powder and liquids is not necessary, as a rule, in the case of the slurry since the components are inert and durable as a rule.

However, if sensitive components or those capable of reacting with each other are present in the recipe, a spatial separation can be provided, e.g. by a membrane or an inner capsule.

The packaging unit itself can be used as a dipping vessel in which a basic body, in particular a dental stump model, can be dipped into the homogenised slurry. The slurry adheres to the basic body then and after being taken out.

In contrast to cement, the slurry can be stored in the premixed form and merely requires to be shaken. Consequently, no storage problems arise since all the components of the composition are inert.

The packaged slurries can also be provided in different pre-metered portions, if necessary in different sizes with different flow behaviour (in paste form, liquid).

A further advantage is that mixing devices available in the dental laboratory can be used, the retaining facility possibly requiring to be adapted to the specific packaging unit by means of an adapter.

According the invention, the kit according to the invention for use in the preparation of ceramic dental prostheses contains packaging units, different packaging units containing different, premetered components for the preparation of different slurry consistencies. In this way, adjusting the material to the specific case of application is possible in a simple manner without problems.

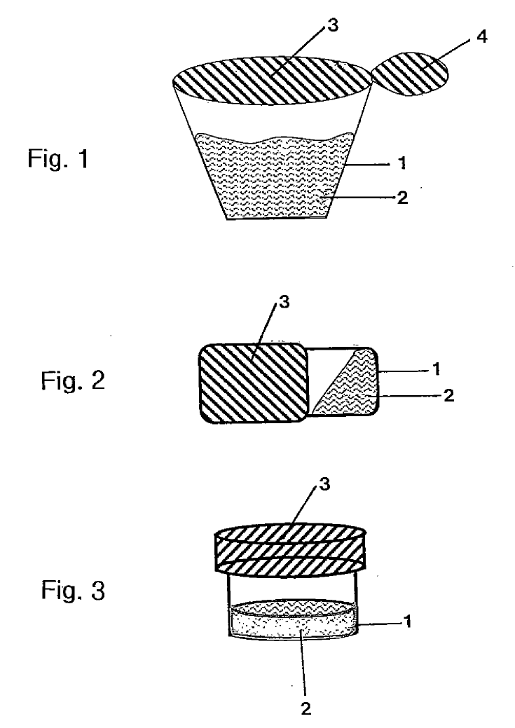

In the following, a practical example of the invention will be illustrated by way of a drawing. In the drawing, FIGS. 1 to 3 show a packaging unit according to the invention.

All the packaging units have the joint feature that a slurry material 2 is present within, that they are closed with a cover 3 and that the capsule 1 can be used for dipping a dental stump model. FIG. 1 shows a capsule 1 with a film as cover 3 which exhibits a peel-off aid 4. In FIG. 2, a type of blister packaging is illustrated and according to FIG. 3 a packaging unit with a cap as cover 3. A dental stump model can be dipped into the homogenised slurry in the case of all the vessels as a result of which it is coated with the slurry.

The slurry material 2 comprises, for example, 20 g of ceramic powder (e.g. Al₂O₃ or ZrO₂) in loose powder form or compressed as pellets and 2,25 g of dispersion liquid which exhibits 0.03 mole/l of citric acid. This corresponds to a slurry volume of approximately 7-8 ml. Depending on the application requirement, the amount of slurry in the packaging unit is between 3 and 30 ml. The components can be present either heterogeneously in the unmixed state or as homogenised slurry. Additives such as e.g. 0.1 g of 10% aqueous solution of polyvinyl alcohol can be added to the slurry material 2.

On shaking by hand, a slurry with isolated lumps is formed. Filling into a bag, sealing and subsequent milling gives a homogeneous slurry after approximately 10 minutes. Mixing in a mixing device or with a vortexer at a frequency of approximately 1 Hz to 20 kHz for a period of approximately 1 second to 30 minutes leads to an excellently homogenised and free-flowing slurry. The period required is all the shorter the higher the frequency. Frequencies of between 10 and 100 Hz are preferred.

1. A packaging unit for homogenizing ceramic slurry in mixing devices, said packaging unit comprising at least one packaging vessel which exhibits a releasable closure, said packaging vessel containing ceramic slurry or its components in pre-metered quantities.

2. Process for homogenizing ceramic slurry, comprising mixing the slurry with a mixing device, wherein the slurry is contained in a packaging unit according to claim 1.

3. Process according to claim 2, wherein said mixing comprises shaking the packaging unit with a shaking frequency of between 1 Hz and 20 kHz and for a shaking time of 30 minutes to 1 second.

4.-5. (canceled)

6. A kit for use for the preparation of ceramic dental protheses, said kit comprising one or more packaging units according to claim 1, where, in the case of multiple packaging units, different packaging units contain different, pre-metered components.

7. A method of forming a ceramic coating on a basic body, said method comprising dipping the basic body into a homogenized ceramic slurry, wherein the slurry is contained in a packaging unit according to claim 1.

8. The method according to claim 7, wherein the basic body is a dental stump model.
